(19) United States
(12) Patent Application Publication
(10) Pub. No.: US 2008/0224065 A1
(43) Pub. Date: Sep. 18, 2008

(54) System and Method for Eluting Radioisotope to a Container Disposed Outside of a Radioisotope Generator Assembly

(76) Inventor: Ralph E. Pollard Jr., Fairfield, OH (US)

Correspondence Address: Mallinckrodt Inc., 675 McDonnell Boulevard, HAZELWOOD, MO, 63042, US

(21) Appl. No.: 12/064,822

(22) PCT Filed: Aug. 28, 2006
(86) PCT No.: PCT/US2006/033442

§ 371 Date: Feb. 26, 2008

Related U.S. Application Data
(60) Provisional application No. 60/712,106, filed on Aug. 29, 2005.

(51) Int. Cl. G21F 5/00

(52) U.S. Cl. 250/432 R; 250/506.1

(57) ABSTRACT

The invention, in one characterization, may be said to be directed to a radiopharmaceutical system that may be utilized in radioisotope elution procedures. In some embodiments, the system may include a radioisotope generator assembly having a radiation shield with a receptacle and a cover disposed over the receptacle. The system may also include a radioisotope generator disposed in the receptacle below the cover. Some embodiments of the system may include an eluate extraction mechanism having an eluate conduit fluidly coupled to a hollow output needle of the radioisotope generator, and a radiation shielded housing disposed outside the radiation shield. The eluate extraction mechanism also may include a hollow needle fluidly coupled to the eluate conduit opposite the radioisotope generator, wherein the hollow needle is disposed inside the radiation shielded housing.

### FIELD OF THE INVENTION

The invention relates generally to the field of nuclear medicine. Specifically, the invention relates to a system and method for eluting a radioisotope from a radioisotope generator to an eluate container disposed outside of an auxiliary shield containing the radioisotope generator.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Nuclear medicine utilizes radioactive material for diagnostic and therapeutic purposes by injecting a patient with a small dose of the radioactive material, which concentrates in certain organs or biological regions of the patient. Radioactive materials typically used for nuclear medicine include Technetium-99m, Indium-113m, and Strontium-87m among others. Some radioactive materials naturally concentrate toward a particular tissue, for example, iodine concentrates toward the thyroid. However, radioactive materials are often combined with a tagging or organ-seeking agent, which targets the radioactive material for the desired organ or biologic region of the patient. These radioactive materials alone or in combination with a tagging agent may be to as radiopharmaceuticals in the field of nuclear medicine. At relatively lower doses of the radiopharmaceutical, a radiation imaging system (e.g., a gamma camera) provides an image of the organ or biological region that collects the radiopharmaceutical. Irregularities in the image are often indicative of a pathologic condition, such as cancer. Higher doses of the radiopharmaceutical may be used to deliver a therapeutic dose of radiation directly to the pathologic tissue, such as cancer cells.

A variety of systems are used to generate, enclose, transport, dispense, and administer radiopharmaceuticals. Unfortunately, these systems often use different containers and shielding structures and, thus, the radiopharmaceuticals tend to be repeatedly exchanged from one container to another during the various steps from elution to eventual administration to a patient. In addition, these systems often involve repeated connection and disconnection of components, such as male and female connectors of containers. Unfortunately, the male connectors can be damaged due to misalignment with the corresponding female connectors. For example, hollow needles can be bent, crushed, or broken due to misalignment with female connectors. As a result, the systems may operate less effectively or become completely useless. If the systems contain radiopharmaceuticals, then the damaged connectors can result in monetary losses, delays with respect to nuclear medicine procedures, and/or undesired exposure of technicians (or other personnel) to radiation.

### SUMMARY

The present invention, in certain embodiments, is directed to removability and replaceability of a hollow needle that pierces an eluate container (e.g., a septum thereof) in a radioisotope elution system. Specifically, in some embodiments, a removable hollow needle may be coupled to a radioisotope generator via an eluate conduit, which in turn may be coupled to an output needle of the radioisotope generator. Instead of directly coupling the eluate container with the output needle of the generator, the removable hollow needle may be used for connections and disconnections with the eluate container. In this manner, the removable hollow needle may reduce the likelihood of damage to the generator output needle, while possibly reducing the cost and downtime associated with any potential damage to the removable hollow needle. In some embodiments, the removable hollow needle may be disposed outside of a radiation shield that is disposed about the radioisotope generator. As such, a user may access and replace the removable hollow needle without opening the radiation shield. Some embodiments of the present invention may enable a user to access and view the eluate container without opening the radiation shield.

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of features and aspects that may not be set forth below.

A first aspect of the invention is directed to a radiopharmaceutical system that includes a radioisotope generator assembly and an eluate extraction mechanism. The radioisotope generator assembly includes a radiation shield having a receptacle, a cover disposed over the receptacle, and a radioisotope generator disposed in the receptacle below the cover. The eluate extraction mechanism includes an eluate conduit fluidly coupled to a hollow output needle of the radioisotope generator, a radiation shielded housing disposed outside the radiation shield, and a hollow needle fluidly coupled to the eluate conduit opposite the radioisotope generator. The hollow needle of the generator is disposed inside the radiation shielded housing of the eluate extraction mechanism. Incidentally, “fluidly coupled” or the like herein refers to a joining of a first component to a second component or to one or more components which may be connected with the second component, or to joining the first component to part of a system that includes the second component so that the molecules of a substance(s) (such as a liquid or gas) are capable of flowing through the system, including through both the first and second components.

A second aspect of the invention is directed to an eluate extraction mechanism that includes a radiation shielded housing and an eluate conduit. The eluate conduit has a radioisotope generator end disposed outside the radiation shielded housing and an opposite end disposed inside the radiation shielded housing. The eluate extraction mechanism also includes a hollow injection needle fluidly coupled to the opposite end of the eluate conduit. In addition, the eluate extraction mechanism includes a plunger coupled to the radiation shielded housing movably through a guide structure. The plunger is typically coupled to the hollow injection needle inside the radiation shielded housing.

Yet a third aspect of the invention is directed to an eluate extraction mechanism that includes a radiation shielded housing and a shielded eluate collection assembly. This shielded eluate collection assembly may be disposed removably inside the radiation shielded housing adjacent a door of the housing. The eluate extraction mechanism includes an eluate conduit having a radioisotope generator end disposed outside the radiation shielded housing and an opposite end disposed inside the radiation shielded housing. In addition, the eluate extraction mechanism includes a hollow needle fluidly coupled to the opposite end of the eluate conduit. The hollow needle may be moved between a connected position and a disconnected position relative to the shielded eluate collection assembly.

Still a fourth aspect of the invention is directed to a method of using a radiopharmaceutical system. In this method, an eluant is supplied into a radioisotope generator, and a radioisotope is eluted in the radioisotope generator. An eluate (including the radioisotope) is received at an output of the radioisotope generator. This eluate flows from the output through an eluate conduit and a hollow needle that is removably inserted, via movement of a plunger, into an eluate container.

Various refinements exist of the features noted above in relation to the various aspects of the present invention. Further features may also be incorporated in these various aspects as well. These refinements and additional features may exist individually or in any combination. For instance, various features discussed below in relation to one or more of the specific embodiments may be incorporated into any of the above-described aspects of the present invention alone or in any combination. Again, the brief summary presented above is intended only to familiarize the reader with certain aspects and contexts of the present invention without limitation to the claimed subject matter.

### BRIEF DESCRIPTION OF THE FIGURES

These and other aspects, features, and advantages of the present invention will become better understood when the following detailed description is read with reference to the accompanying figures in which like characters represent like parts throughout the figures, wherein:

FIG. 1 is a front perspective view of an exemplary embodiment of a radioisotope elution system including an eluate extraction mechanism disposed outside a radioisotope generator assembly, wherein the eluate extraction mechanism is disposed above a cover of an auxiliary shield containing a radioisotope generator, and the eluate extraction mechanism includes a plunger;

FIG. 2 is a rear perspective view of the radioisotope elution system as illustrated in FIG. 1, further illustrating a door coupled to the eluate extraction mechanism via a hinge;

FIG. 3 is a cross-sectional side view of the radioisotope elution system as illustrated in FIGS. 1 and 2, further illustrating the eluate extraction mechanism in an open, non-circulating configuration, wherein the door is rotated open and the plunger includes a hollow injection needle uncoupled from an eluate container;

FIG. 4 is a cross-sectional side view of the radioisotope elution system as illustrated in FIG. 3, further illustrating the eluate extraction mechanism in a closed, circulating configuration, wherein the door is rotated closed and the hollow injection needle is coupled to the eluate container;

FIG. 5 is a rear perspective view of the radioisotope elution system as illustrated in FIG. 4, further illustrating an open viewing slot in a shielded eluate assembly having the eluate container disposed inside;

FIG. 6 is a cross-sectional side view of the radioisotope elution system as illustrated in FIG. 5, further illustrating the shielded eluate assembly removed from the eluate extraction mechanism when the hollow injection needle is uncoupled from the eluate container and the door is disposed in an open position;

FIG. 7 is an exploded cross-sectional side view of the radioisotope elution system as illustrated in FIG. 6, illustrating the hollow injection needle removed from the plunger of the eluate extraction mechanism;

FIG. 8 is an exploded cross-sectional view of the eluate extraction mechanism as illustrated in FIG. 7, further illustrating details of the hollow injection needle removed from the plunger of the eluate extraction mechanism;

FIG. 9 is a top perspective view of an exemplary embodiment of the plunger as illustrated in FIG. 8, further illustrating a removable fluid coupling disposed at a bottom side of the plunger;

FIG. 10 is a bottom perspective view of the plunger as illustrated in FIG. 9;

FIG. 11 is an exploded perspective view of the plunger as illustrated in FIGS. 9 and 10, further illustrating the removable fluid coupling having a bossed portion or rail exploded laterally from a slot in the bottom side of the plunger;

FIG. 12 is a side view of an embodiment of the removable fluid coupling as illustrated in FIGS. 9-11;

FIG. 13 is a bottom view of an embodiment of the plunger as illustrated in FIGS. 9-11, further illustrating the plunger without the removable fluid coupling;

FIGS. 14 and 15 are rear perspective views of the eluate extraction mechanism as illustrated in FIGS. 1-8, further illustrating an alignment adapter disposed about an eluate conduit of the eluate extraction mechanism;

FIG. 16 is a flowchart illustrating an exemplary embodiment of a nuclear medicine process using a radiopharmaceutical acquired by the radioisotope elution system as illustrated in FIGS. 1-15;

FIG. 17 is a block diagram illustrating an exemplary embodiment of a radiopharmacy or system utilizing the radioisotope elution system as illustrated in FIGS. 1-15; and

FIG. 18 is a block diagram illustrating an exemplary embodiment of a nuclear imaging system utilizing a radiopharmaceutical acquired by the radioisotope elution system as illustrated in FIGS. 1-15.

### DETAILED DESCRIPTION OF SPECIFIC EMBODIMENTS

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

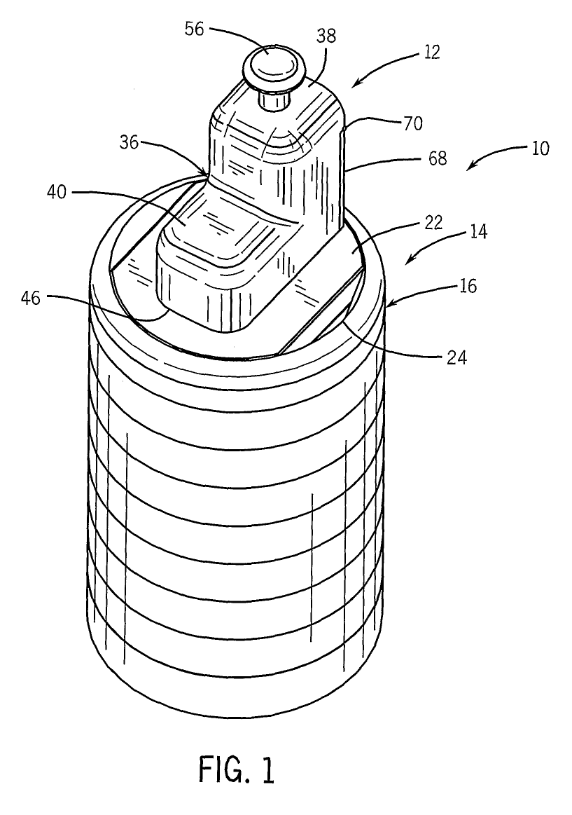

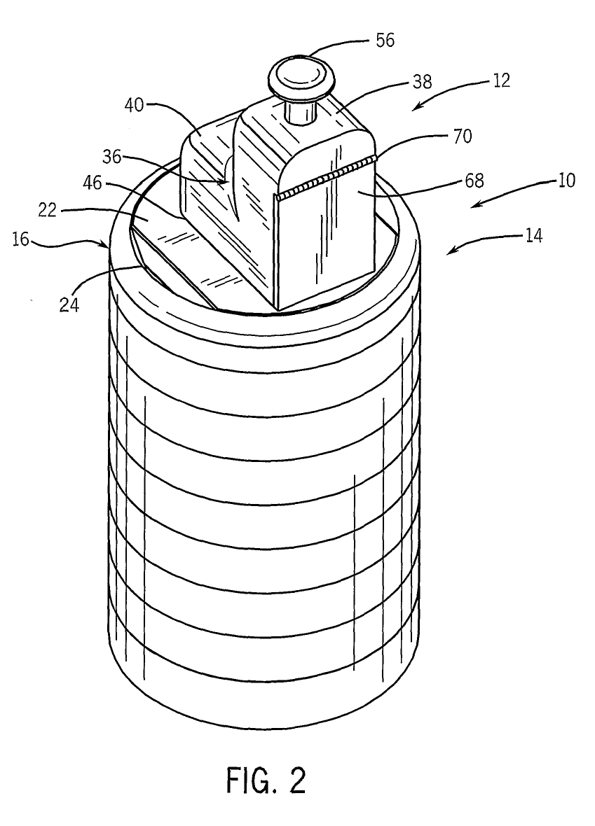

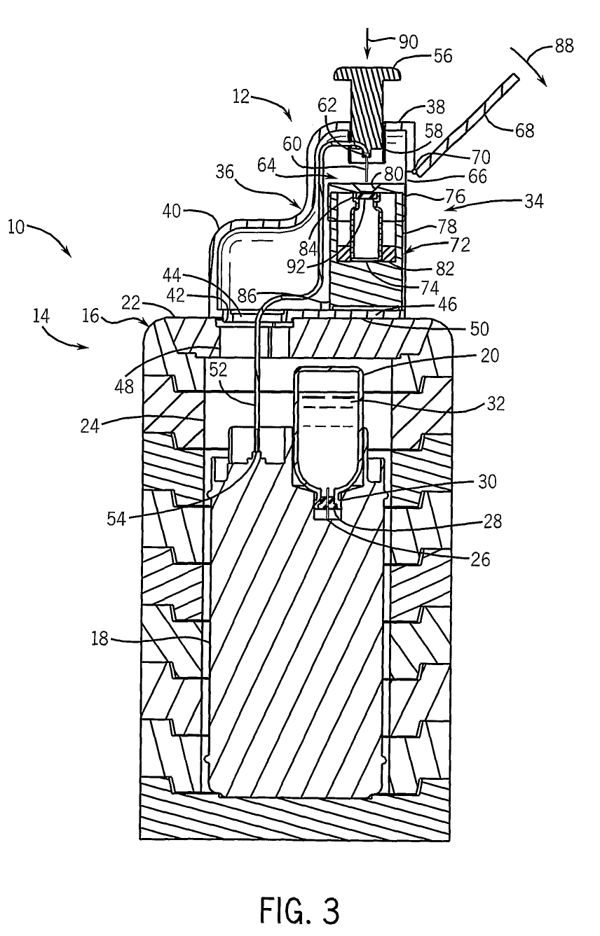

FIGS. 1 and 2 are perspective views of an exemplary embodiment of a radioisotope elution system 10 having an eluate extraction mechanism 12 mounted outside, and specifically on top of, a radioisotope generator assembly 14. The radioisotope generator assembly 14 may include a radiation shielded container or auxiliary shield 16, which may receive and at least substantially enclose a radioisotope generator 18 and an eluant supply container 20 as discussed below with reference to FIG. 3. The eluate extraction mechanism 12 and the auxiliary shield 16 may include a variety of radiation-shielding materials, such as lead, tungsten, tungsten impregnated plastic and/or another suitable radiation shielding material. The eluate extraction mechanism 12 may be mounted at least partially or entirely outside of the auxiliary shield 16 in a variety of configurations, orientations, and positions, such that an elution process may be performed to output an eluate to a position outside of the auxiliary shield 16. For example, the eluate extraction mechanism 12 may be mounted along a generally horizontal surface on top of a cover 22 that generally closes a receptacle 24 of the auxiliary shield 16. Alternatively, the eluate extraction mechanism 12 may be mounted to the auxiliary shield 16 along a generally vertical surface or a side of the auxiliary shield 16. Alternatively, the eluate extraction mechanism 12 may be mounted separate from the radioisotope generator assembly 14. For example, the eluate extraction mechanism 12 may be disposed next to, above, below, or in a variety of remote locations relative to the radioisotope generator assembly 14, wherein an eluate conduit 52 may couple the eluate extraction mechanism 12 to the radioisotope generator assembly 14 as discussed in further detail below with reference to FIG. 3.

In the illustrated embodiment of FIGS. 1 and 2, the eluate extraction mechanism 12 may be removably coupled to the cover 22, such that the eluate extraction mechanism 12 can be installed and removed without removing the cover 22 from the receptacle 24. In this manner, the eluate extraction mechanism 12 may improve the containment of radioactivity from the radioisotope generator 18 disposed within the auxiliary shield 16. If the radioisotope generator assembly 14 is not being used for an elution process, then the eluate extraction mechanism 12 may be removed and replaced with a radiation shielded plug that may extend into and/or cover the passage 48 in the cover 22. If an elution process is desired now or in the near future, then the radiation shielded plug may be removed and replaced with the eluate extraction mechanism 12 on or over the cover 22. The eluate extraction mechanism 12 may be removably coupled to the cover 22 by a variety of fasteners and alignment structures. For example, the fasteners may include screws, bolts, or other threaded fasteners. The fasteners also may include latches or tool free connectors, such as snap-fit mechanisms, boss members that mate with keyhole slots, and so forth. The fasteners may also include hinges, adhesives, and compressive or interference fits. Alternatively, the eluate extraction mechanism 12 and the cover 22 may be integrally formed as one structure, which may be mounted on top of the auxiliary shield 16.

FIG. 3 is a cross-sectional side view of an embodiment of the radioisotope elution system 10 as illustrated in FIGS. 1 and 2, further illustrating the eluate extraction mechanism 12 in an open, non-circulating configuration on top of the radioisotope generator assembly 14. As illustrated, the radioisotope generator assembly 14 may include the auxiliary shield 16 and the radioisotope generator 18 disposed in the receptacle 24 below the cover 22 of the auxiliary shield 16. The radioisotope generator assembly 14 also may include the eluant supply container 20 coupled to one or more hollow input needles 26 of the radioisotope generator 18. For example, the one or more hollow input needles 26 may pierce a flexible insert 28, such as a rubber material, disposed within a head 30 of the eluant supply container 20. In this manner, the one or more hollow input needles 26 fluidly couple the eluant supply container 20 with an internal radioisotope element, such as molybdenum-99, disposed inside the radioisotope generator 18. The eluant supply container 20 may be disposed entirely or at least substantially inside the auxiliary shield 16 in the receptacle 24 below the cover 22, as illustrated in FIG. 3. Alternatively, the eluant supply container 20 may be disposed at least partially or entirely outside the auxiliary shield 16 in other embodiments of the radioisotope elution system 10. As discussed in further detail below, the eluant supply container 20 may hold a variety of eluants, such as a saline solution, suitable for eluting a radioisotope (e.g., technetium-99m) from the radioisotope generator 18 into the eluate extraction mechanism 12.

As illustrated in FIG. 3, the eluate extraction mechanism 12 may have a shielded eluate assembly 34 disposed removably inside a radiation shielded housing 36 on top of the cover 22. The illustrated radiation shielded housing 36 may have a variety of shapes and configurations. For example, the radiation shielded housing 36 may have a generally L-shaped or angled structure having a top or elongated housing portion 38 and a bottom housing portion 40.

The radiation shielded housing 36 also may have a cover alignment member 42 disposed about an opening 44 in a base 46. In certain embodiments, the cover alignment member 42 may improve the alignment of the eluate extraction mechanism 12 with a passage 48 through the cover 22 of the auxiliary shield 16. For example, the base 46 may have a generally flat bottom surface 50, and the cover alignment member 42 may protrude outwardly from the flat surface 50. In view of this protruding characteristic, the cover alignment member 42 may fit or extend at least partially inside or through the passage 48 when the eluate extract mechanism 12 is mounted on the cover 22. In this manner, the cover alignment member 42 may increase the likelihood of proper alignment with the radioisotope generator 18 disposed inside the auxiliary shield 16. For example, the cover alignment member 42 may improve alignment between conduits, hollow needles, and various connections between the eluate extraction mechanism 12 and the radioisotope generator 18.

Regarding the various fluid connections, the eluate extraction mechanism 12 of FIG. 3, for example, may include an eluate conduit 52 that may pass through the radiation shielded housing 36 and the passage 48 in the cover 22. At one end, the eluate conduit 52 may be coupled with a hollow output needle 54 on the radioisotope generator 18. At an opposite end from the hollow output needle 54, the eluate conduit 52 may be coupled to a plunger 56 movably coupled to the eluate extraction mechanism 12 along a path of travel, e.g., a linear path of vertical motion. For example, the plunger 56 may be moveably disposed in a guide structure or passage 58 within the top or elongated housing portion 38 of the eluate extraction mechanism 12. The plunger 56 also may include a hollow injection needle 60 or another suitable fluid connector. Thus, the plunger 56 and the hollow injection needle 60 may be jointly moved along a path of travel between a connected position and a disconnection position between the hollow injection needle 60 and an eluate container 74 as discussed in further detail below. The hollow injection needle 60, or other suitable fluid connector, may be removably coupled to the eluate conduit 52 via a releasable fastener 62. For example, the fastener 62 may include a luer connection, a compression fit mechanism, a threaded joint, snap-fit members, latches, or another release mechanism.

As discussed in detail below, the hollow injection needle 60 may be accessed, removed, serviced, or replaced independent and remote from the hollow output needle 54 on the radioisotope generator 18. Moreover, the coupling of the eluate conduit 52 and the hollow output needle 54 may be maintained during the life or use of a radioisotope generator 18, thereby reducing the likelihood of bending or damaging the hollow output needle 54. Instead, over the course of repeated use of the radioisotope elution system 10, the hollow injection needle 60 may be repeatedly connected and disconnected with the shielded eluate assembly 34. In view of the removability of the hollow injection needle 60, any bending or damage may be easily and cheaply serviced by replacing the needle 60 rather than the entire radioisotope generator 18. Moreover, the hollow injection needle 60 is disposed outside the auxiliary shield 16, such that servicing may be performed without removing the cover 22 and being exposed to radiation from the radioisotope generator 18.

As further illustrated in FIG. 3, the shielded eluate assembly 34 may be inserted and removed from a region 64 generally below the plunger 56 via a door opening 66 along a side of the top or elongated housing portion 38. The radiation shielded housing 36 also includes a selective access door 68 having a hinge 70 coupled to the elongated housing portion 38 adjacent the door opening 66. Accordingly, radiation shielded housing 36 including the door 68 may provide substantially continuous radioactive shielding about the shielded eluate assembly 34 outside of the auxiliary shield 16, while the door 68 and opening 66 may enable a user to view and selectively access the shielded eluate assembly 34 quickly and easily without opening the auxiliary shield 16. In addition, as discussed below, the shielded eluate assembly 34 may have a variety of features, such as a slot 93 and a door 94, to enable viewing of the extracted eluate. As illustrated in FIG. 3, the door 68 can open and close the door opening 66 for selective access, insertion, and removal of the shielded eluate assembly 34. In other embodiments, the door 68 may be coupled to the radiation shielded housing 36 via a sliding mechanism, a spring-loaded mechanism, a swinging mechanism, or another suitable opening and closing mechanism configured to enable selective access, viewing, insertion, and removal of the shielded eluate assembly 34.

The shielded eluate assembly 34 as illustrated in FIG. 3 may include an eluate container shield 72 disposed about an eluate container 74, such as an evacuated vial, bottle, or other container in a vacuum condition. The eluate container shield 72 may include a variety of radiation-shielding materials, such as lead, tungsten, tungsten impregnated plastic and/or another suitable radiation shielding material. The eluate container 74 may include a variety of transparent or translucent materials, such as glass. The eluate container shield 72 may include a cap 76 coupled to a shielded cup structure 78, such that the eluate container 74 may be generally aligned with an opening 80 through the cap 76. The cap 76 may be coupled to the shielded cup structure 78 via threads, an interference fit, a snap-fit mechanism, or another suitable attachment mechanism. The eluate container 74 may be aligned with the opening 80 via a variety of alignment mechanisms, such as an alignment adapter or ring 82 disposed about the eluate container 74 inside the shielded cup structure 78. Alternatively, the opening 80 may have a protruding portion facing downwardly toward a head 84 of the eluate container 74, such that the head 84 may be aligned with the opening 80.

The eluate extraction mechanism 12 as illustrated in FIG. 3 may also include a variety of alignment mechanisms to improve alignment of the shielded eluate assembly 34 relative to the hollow injection needle 60 coupled to the plunger 56. For example, the eluate extraction mechanism 12 may include one or more alignment members or tabs 86 along the base 46 of the radiation shielded housing 84. The alignment members or tabs 86 may increase the likelihood that the shielded eluate assembly 34 fits snugly between the tab 86 and the door 68 when the door 68 is closed over the door opening 66. In addition to the snug fit, the alignment members or tabs 86 may position a center of the head 84 (and longitudinal axis) of the eluate container 74 with a longitudinal axis of the hollow injection needle 60 and the direction of motion of the plunger 56. In this manner, the hollow injection needle 60 may be connected and disconnected in a generally centered and straight direction into and out of the eluate container 74, thereby reducing the likelihood of bending or damaging the hollow injection needle 60. Again, a variety of fasteners, alignment mechanisms, containers, and configurations of the eluate extraction mechanism 12 may be employed to elute a radioisotope to the shielded eluate assembly 34 generally outside the confines of the radioisotope generator assembly 14.

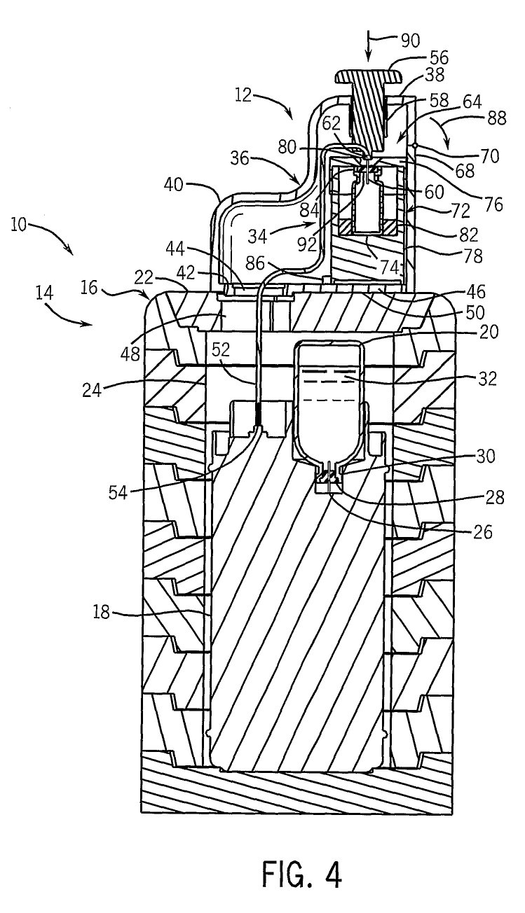

FIG. 4 is a cross-sectional side view of and embodiment of the radioisotope elution system 10 as illustrated in FIG. 3, further illustrating the eluate extraction mechanism 12 disposed in a closed, fluidly coupled configuration with the radioisotope generator assembly 14. As illustrated by arrow 88, the door 68 has been rotated about the hinge 70 to close the door opening 66, such that the shielded eluate assembly 34 may be snuggly fit between the alignment tab 86 and the door 68. In this manner, the alignment tab 86 and the door 68 can secure and align the opening 80 in the eluate container shield 72 in a generally centered position with the hollow injection needle 60 of the plunger 56. In addition, the head 84 of the eluate container 74 may be generally aligned or centered with the opening 80 and the hollow injection needle 60 via the alignment adapter or ring 82 disposed about the eluate container 74 inside the shielded cup structure 78. With the eluate container 74 generally aligned or centered with the hollow injection needle 60, the plunger 56 may be depressed downwardly as indicated by arrow 90 to pierce the hollow injection needle 60 into the eluate container 74 through a flexible insert 92, such as a rubber material, in the head 84 of the eluate container 74.

In certain embodiments, the eluate container 74 may be in vacuum, such that the pressure differential between the eluant supply container 20 and the eluate container 74 facilitates circulation of the eluant 32 through the radioisotope generator 18 and out through the eluate conduit 52 into the eluate container 74. As the eluant 32, e.g., a saline solution, circulates through the radioisotope generator 18, the circulating eluant 32 generally washes out or elutes a radioisotope, e.g., Technetium-99m. For example, one embodiment of the radioisotope generator 18 includes a radiation shielded outer casing (e.g., lead shell) that encloses a radioactive parent, such as molybdenum-99, adsorbed to the surfaces of beads of alumina or a resin exchange column. Inside the radioisotope generator 18, the parent molybdenum-99 transforms, with a half-life of about 67 hours, into metastable technetium-99m. The daughter radioisotope, e.g., technetium-99m, is generally held less tightly than the parent radioisotope, e.g., molybdenum-99, within the radioisotope generator 18. Accordingly, the daughter radioisotope, e.g., technetium-99m, can be extracted or washed out with a suitable eluant, such as an oxidant-free physiologic saline solution. The eluate output from the radioisotope generator 18 into the eluate container 74 generally includes the eluant 32 and the washed out or eluted radioisotope from within the radioisotope generator 18. Upon receiving the desired amount of eluate within the eluate container 74, the plunger 56 may be withdrawn outwardly from the shielded eluate assembly 34, such that the circulation and output of eluate is terminated. As discussed in further detail below, the extracted daughter radioisotope can then, if desired, be combined with a tagging agent to facilitate diagnosis or treatment of a patient (e.g., in a nuclear medicine facility).

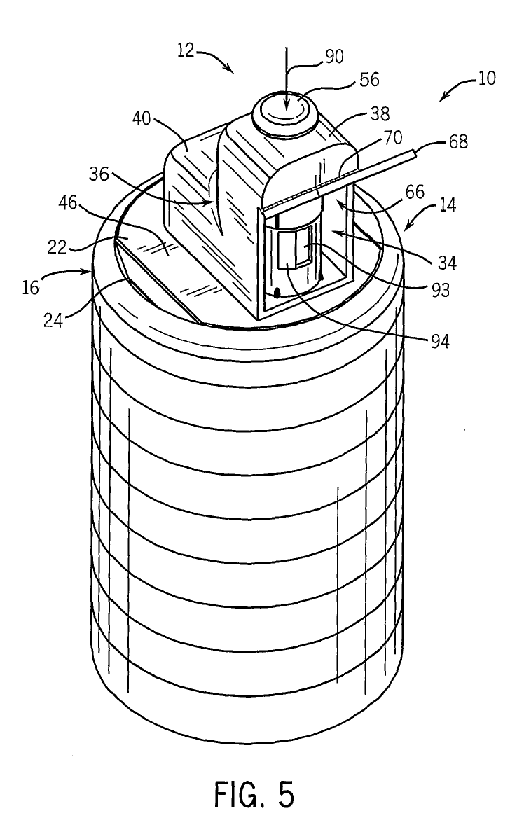

After or during the elution process, the door 68 may be rotated open to view the level or amount of eluate collected within the eluate container 74. For example, the eluate container shield 72 may include one or more viewing windows or openings to enable a user to view the quantity of eluate within the container 74. FIG. 5 is a rear perspective view of an embodiment of the radioisotope elution system 10 of FIG. 4, further illustrating the eluate extraction mechanism 12 with the plunger 56 depressed and the door 68 opened to enable viewing of the eluate through a viewing window or slot 93 in the shielded cup structure 78 of the shielded eluate assembly 34. The slot 93, if included, also may be removably covered by a door 94 disposed along the outer walls of the shielded cup structure 78. In certain embodiments, the door 94 may include a sliding door, a rotating door, a sleeve disposed about the shielded eluate assembly 34, or another suitable mechanism for opening and closing the viewing window or slot 93.

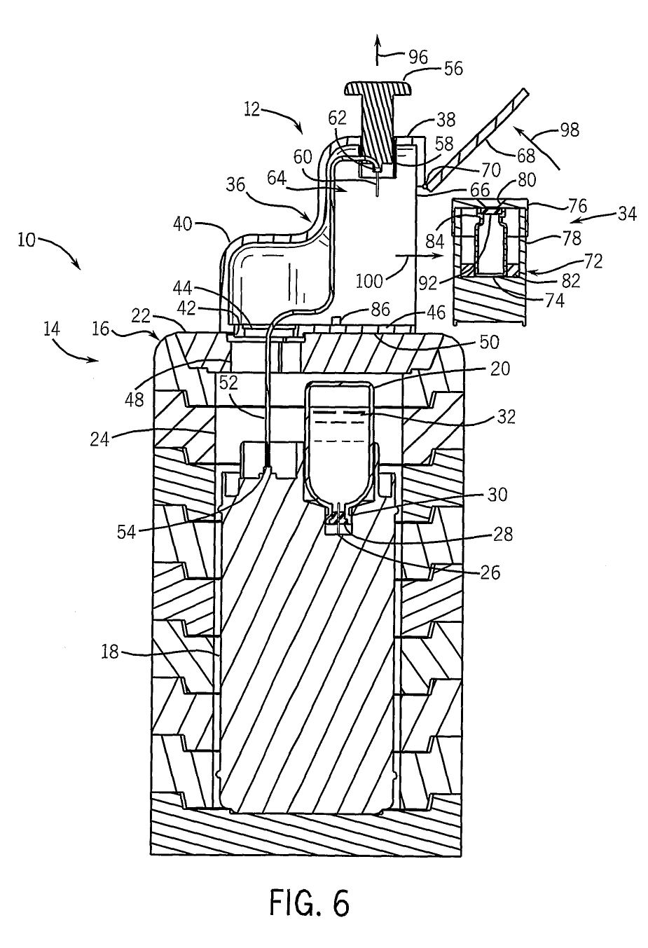

FIG. 6 is a cross-sectional side view of an embodiment of the elution system 10 of FIGS. 3 and 4, further illustrating the plunger 56 withdrawn in an upward direction as indicated by arrow 96, the door 68 opened in a counterclockwise direction as indicated by arrow 98, and the shielded eluate assembly 34 withdrawn from the eluate extraction mechanism 12 in an outward direction as indicated by arrow 100. In certain embodiments, the shielded eluate assembly 34 may be a radiopharmaceutical dosing assembly, such that one or more doses of the radioisotope may be extracted directly into a syringe or other container for delivery to a hospital or other medical facility. In other words, the eluate extraction mechanism 12 may reduce the number of shielded containers involved in the radiopharmaceutical preparation process within a radiopharmacy. For example, the eluate extraction mechanism 12 may eliminate the use of a shielded eluate container configured to fit within the passage 48 in the cover 22 and/or with the top side of the radioisotope generator 18 inside the auxiliary shield 16. Thus, the eluate extraction mechanism 12 enables output of the eluate directly into the shielded eluate assembly 34, which may then be used to prepare one or more radiopharmaceutical doses without first transferring the eluate to another shielded container assembly.

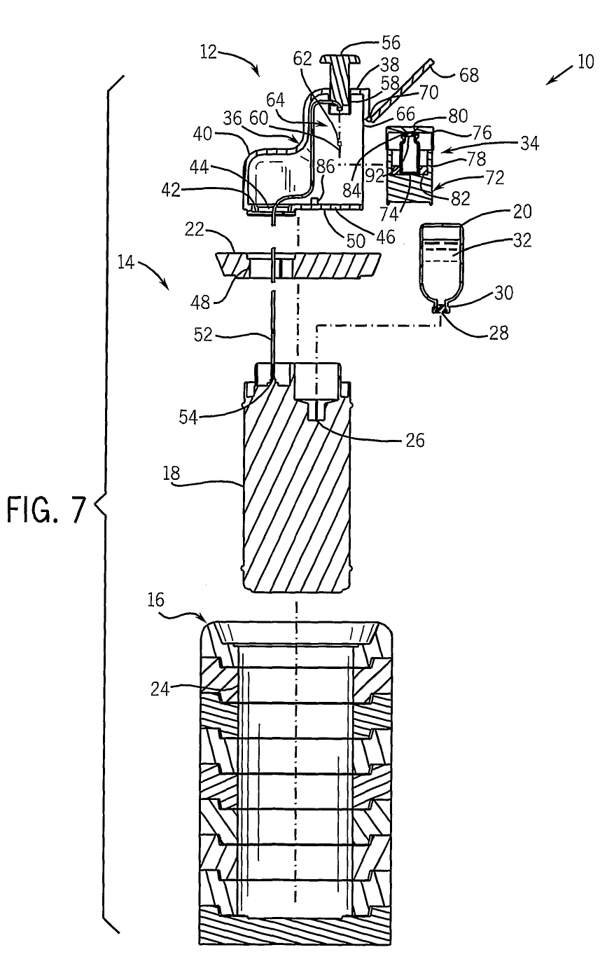

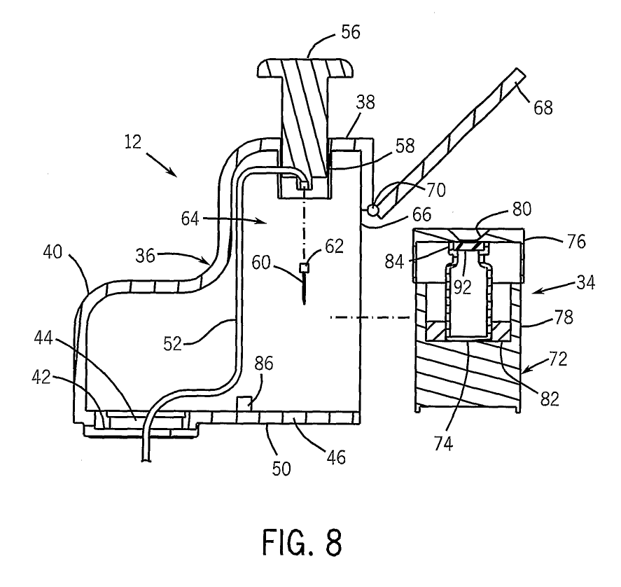

FIG. 7 is an exploded cross-sectional side view of an embodiment of the radioisotope elution system 10 of FIG. 6, further illustrating the removability and replaceability of various components including the hollow injection needle 60 of the eluate extraction mechanism 12. In addition, FIG. 8 is an exploded cross-sectional side view of an embodiment of the eluate extraction mechanism 12, further illustrating the removability and replaceability of the hollow injection needle 60. As illustrated, if the hollow injection needle 60 becomes damaged, bent, clogged, or inoperable during an elution process, then the hollow injection needle 60 may be removed and replaced with another needle 60 to ensure proper circulation of fluids through the elution system 10 into the shielded eluate assembly 34. The eluate extraction mechanism 12 and the removable hollow injection needle 60 may increase the life and operational efficiency of the radioisotope generator assembly 14, for example, by substantially reducing the likelihood of an inoperable generator assembly 14 that may be caused by damage to the hollow output needle 54 coupled to the radioisotope generator 18, among other reasons.

In other words, after making the initial connection between the hollow output needle 54 of the radioisotope generator 18 and the eluate conduit 52 of the eluate extraction mechanism 12, the connections and disconnections with the eluate container 74 may be made with the plunger 56 and the hollow injection needle 60 rather than the hollow output needle 54. For example, each time an amount of eluate is desired from the radioisotope generator 18, the hollow injection needle 60 may be inserted into the eluate container 74 and then removed after the amount of eluate is collected in the container 74. However, the eluate conduit 52 may remain continuously coupled to the hollow output needle 54 of the radioisotope generator 18 during each elution process. Therefore, any likelihood of potential damage to the eluate output connectors (e.g., hollow needles) may be moved away from the radioisotope generator 18 to the eluate extraction mechanism 12. Any potential damage to hollow injection needle 60 can be easily and cheaply addressed by replacing the hollow injection needle 60, whereas the relatively lower potential for damage to the hollow output needle 54 may be addressed by replacing the entire radioisotope generator 18. For these reasons, the removability and replaceability of the hollow injection needle 60 may reduce downtime, costs, and difficulty in repairing the system 10 in the event of damage to the eluate output connectors.

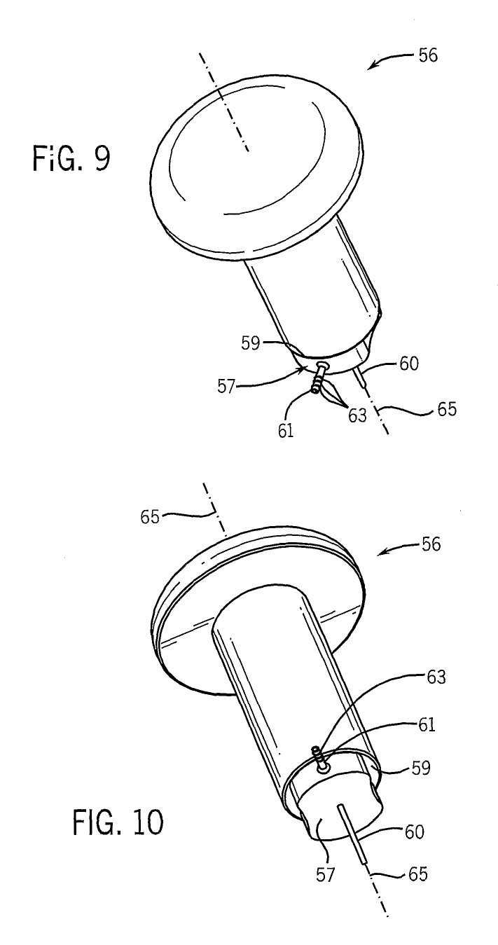

FIGS. 9-13 are various views of an embodiment of the plunger 56, further illustrating connection mechanisms for the eluate conduit 52 and the hollow injection needle 60. FIGS. 9 and 10 are top and bottom perspective views of the plunger 56 illustrating a removable fluid coupling 57 that may be removably coupled to a bottom side 59 of the plunger 56. As illustrated in FIGS. 9 and 10, the removable fluid coupling 57 may include an eluate conduit connector 61 extending laterally from the coupling 57, such that the eluate conduit 52 can fit securely and removably about the connector 61. The illustrated eluate conduit connector 61 also may include a variety of raised and lowered portions, such as a series of rings 63, to resist separation between the eluate conduit 52 (e.g., a flexible tube) and the connector 61. In the illustrated embodiment, the connector 61 is oriented at about 90 degrees relative to the hollow injection needle 60. However, the connector 61 may be oriented at a variety of angles in other embodiments of the plunger 56. The hollow injection needle 60 may be generally aligned with a centerline 65 of the plunger 56, such that the needle 60 can be inserted and removed in a straight direction relative to the centerline of the eluate container 74. In certain embodiments, the hollow injection needle 60 may be removably coupled to the removable fluid coupling 57. Alternatively, the hollow injection needle 60 may be an integral portion of the removable fluid coupling 57. In either embodiment, the hollow injection needle 60 may be quickly removed and inexpensively replaced if the needle 60 becomes damaged during use.

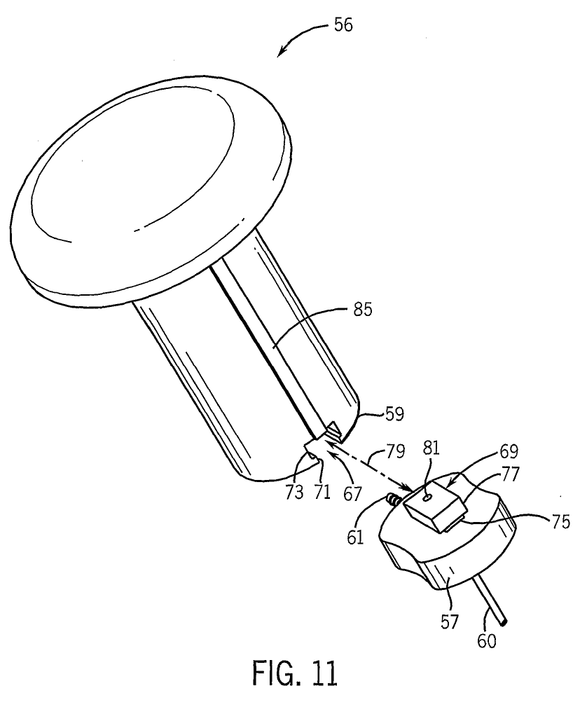

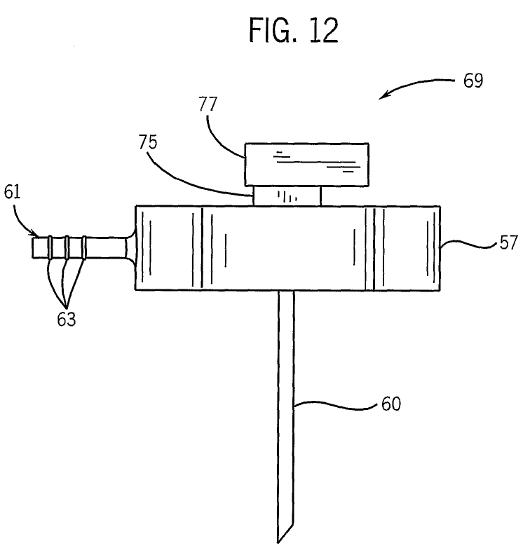

For example, turning to FIG. 11, the plunger 56 may include a slot 67 (e.g., a T-shaped slot) to receive a bossed portion or rail 69 (e.g., a T-shaped head) of the removable fluid coupling 57. As illustrated in FIG. 11, the slot 67 may include a narrow outer opening 71 leading into an enlarged inner channel 73. Similarly, the bossed portion 69 may include a narrow inner portion 75 leading to an enlarged outer portion 77. FIG. 12 is a side view of the removable fluid coupling 57, further illustrating the geometry of the portions 75 and 77. As indicated by arrow 79 in FIG. 11, the fluid coupling 57 may removably couple with the plunger 56 by laterally or horizontally moving the bossed portion or rail 69 into the slot 67. In this manner, the fluid coupling 57 may be vertically interlocked with the plunger 56. In addition, the top of the bossed portion or rail 69 may include a detent 81 to interlock removably with a protrusion 83 inside the slot 67, as illustrated in FIGS. 11 and 13. In certain embodiments, the detent 81 illustrated in FIG. 11 may be a concave recess, and the protrusion 83 illustrated in FIG. 13 may be a convex protrusion or ball-shaped portion. FIG. 13 is a bottom view of the plunger 56 illustrating an embodiment of the protrusion 83 positioned toward the interior or center of the plunger 56. At this interior position, the protrusion 83 may engage the detent 81 as the bossed portion or rail 69 of the removable fluid coupling 57 slides into the slot 67 of the plunger 56. In certain embodiments, the protrusion 83 and the detent 81 may snap-fit together, thereby removably securing the bossed portion or rail 69 in a lateral or horizontal direction relative to the slot 67. In this manner, a user may quickly install, remove, and replace the removable fluid coupling 67 relative to the slot 67 and rail 69 via the vertical interlocking between the slot 67 and rail 69 and the horizontal interlocking between the detent 81 and protrusion 83. In other embodiments, the removable fluid coupling 67 may be coupled to the plunger 56 via threads, latches, pin and grooves, and so forth.

Referring again to FIG. 11, the plunger 56 may include one or more guiding rails 85, which may extend vertically lengthwise along the exterior of the plunger 56. These guiding rails 85 may have a generally rectangular geometry or another suitable geometry, which slides lengthwise along a mating portion of the guide structure or passage 58 within the radiation shielded housing 36. In this manner, the guiding rails 85 may ensure proper alignment of the hollow injection needle 60 relative to the eluate container 74 and, also, ensure proper positioning of the eluate conduit connector 61 relative to the eluate conduit 52. However, other embodiments of the plunger 56 may employ a variety of alternative alignment mechanisms.

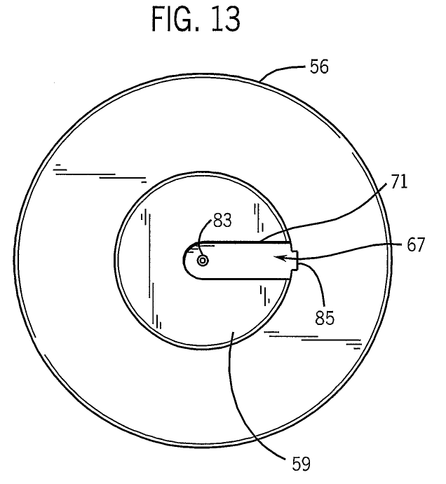

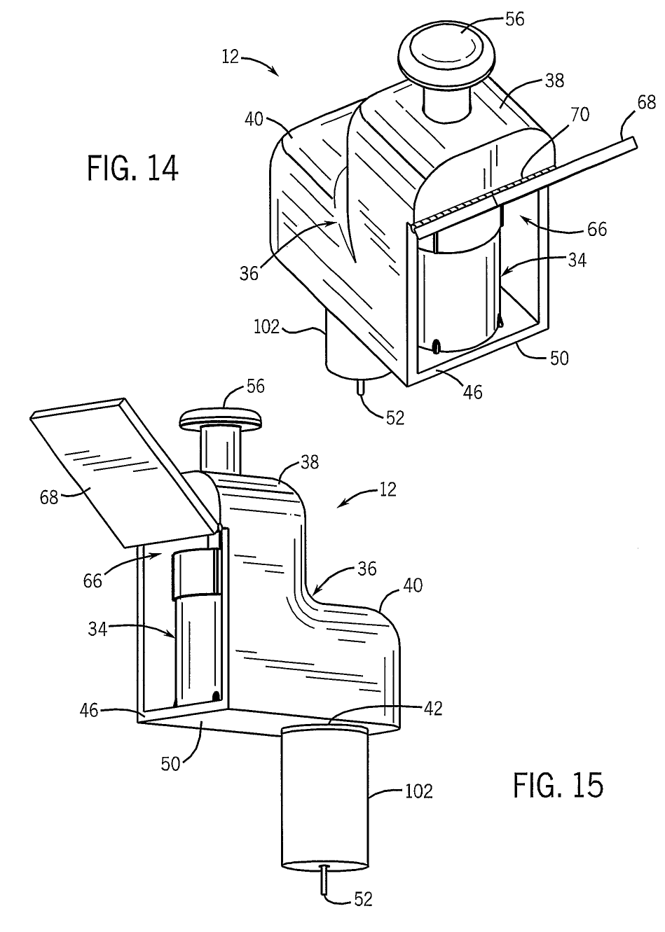

FIGS. 14 and 15 are perspective views of an embodiment of the eluate extraction mechanism 12, further illustrating alignment features that may facilitate alignment with the radioisotope generator assembly 14. As illustrated, the radiation shielding housing 84 has a generally L-shaped or 90 degree elbow-shaped geometry. However, any other suitable shapes, structures, or geometries are within the scope of the disclosed system. Moreover, the cover alignment member 42 may have a variety of shapes and configurations to facilitate alignment of the eluate extraction mechanism 12 and the eluate conduit 52 with the radioisotope generator assembly 14. For example, the cover alignment member 42 may have an elongated portion 102, such as an alignment adapter, that may be configured to fit and align with the passage 48 in the cover 22 and a top portion of the radioisotope generator 18. The elongated portion 102 may be an integral part of the eluate extraction mechanism 12 or the elongated portion 102 may be a removable structure having a suitable fastener, such as threads, latches, or snap-fit members, among other fasteners. In addition, the conduit 52 may be at least partially rigid (or rigidly supported) to facilitate the connection and alignment with the hollow output needle 54 of the radioisotope generator 18. For example, the eluate conduit 52 may be supported along most of its length by the alignment portion 102, such that the eluate conduit 52 may be generally centered with the hollow output needle 54 of the radioisotope generator 18 during insertion and removal of the eluate extraction mechanism 12 relative to the cover 22. However, a variety of mounting mechanisms and alignment devices may be utilized with the eluate extraction mechanism 12.

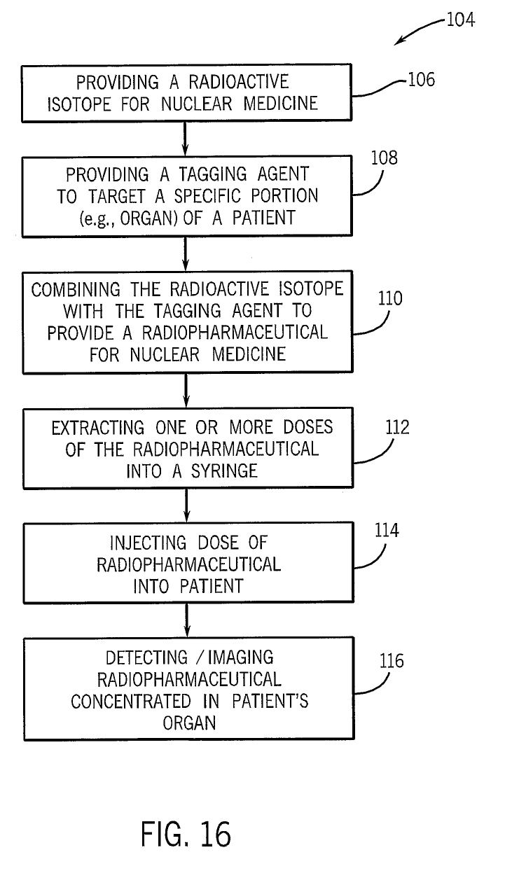

FIG. 16 is a flowchart illustrating an exemplary nuclear medicine process utilizing the radioactive isotope produced by the elution system 10 illustrated with reference to FIGS. 1-15. As illustrated, the process 104 begins by providing a radioactive isotope for nuclear medicine at block 106. For example, block 106 may include eluting technetium-99m from the radioisotope generator 18 illustrated and described in detail above. At block 108, the process 104 proceeds by providing a tagging agent (e.g., an epitope or other appropriate biological directing moiety) adapted to target the radioisotope for a specific portion, e.g., an organ, of a patient. At block 110, the process 104 then proceeds by combining the radioactive isotope with the tagging agent to provide a radiopharmaceutical for nuclear medicine. In certain embodiments, the radioactive isotope may have natural tendencies to concentrate toward a particular organ or tissue and, thus, the radioactive isotope may be characterized as a radiopharmaceutical without adding any supplemental tagging agent. At block 112, the process 104 then may proceed by extracting one or more doses of the radiopharmaceutical into a syringe or another container, such as a container suitable for administering the radiopharmaceutical to a patient in a nuclear medicine facility or hospital. At block 114, the process 1 04 proceeds by injecting or generally administering a dose of the radiopharmaceutical into a patient. After a pre-selected time, the process 104 proceeds by detecting/imaging the radiopharmaceutical tagged to the patient's organ or tissue (block 116). For example, block 116 may include using a gamma camera or other radiographic imaging device to detect the radiopharmaceutical disposed on or in or bound to tissue of a brain, a heart, a liver, a tumor, a cancerous tissue, or various other organs or diseased tissue.

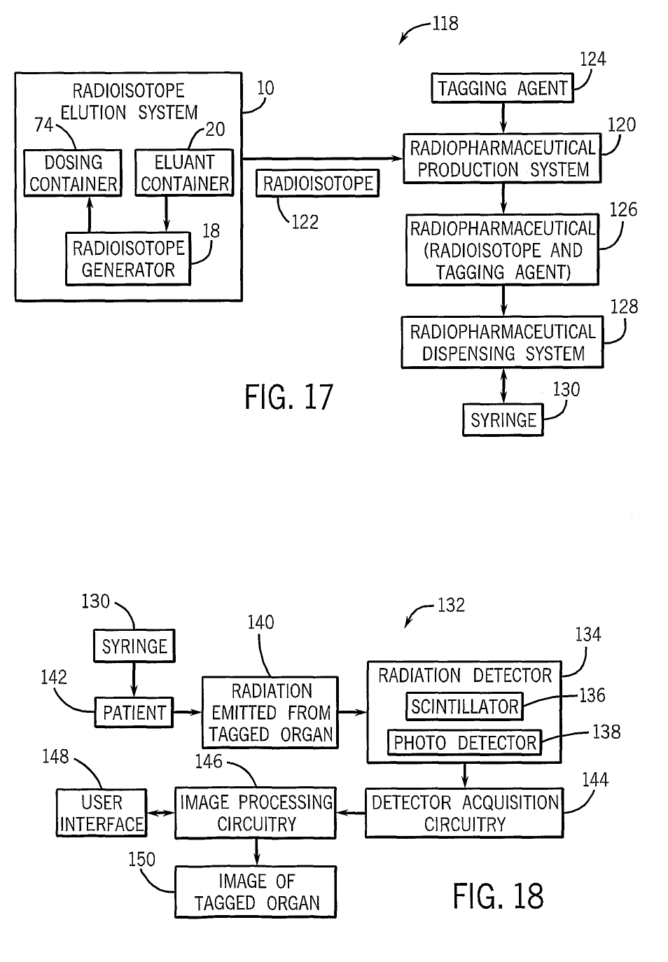

FIG. 17 is a block diagram of an exemplary system 118 for providing a syringe having a radiopharmaceutical disposed therein for use in a nuclear medicine application. As illustrated, the system 118 includes the radioisotope elution system 10 previously described with regard to FIGS. 1-15. The system 118 also includes a radiopharmaceutical production system 120, which functions to combine a radioisotope 122 (e.g., technetium-99m solution acquired through use of the radioisotope elution system 10) with a tagging agent 124. In some embodiment, this radiopharmaceutical production system 120 may refer to or include what are known in the art as “kits” (e.g., Technescan® kit for preparation of a diagnostic radiopharmaceutical). Again, the tagging agent may include a variety of substances that are attracted to or targeted for a particular portion (e.g., organ, tissue, tumor, cancer, etc.) of the patient. As a result, the radiopharmaceutical production system 120 produces or may be utilized to produce a radiopharmaceutical including the radioisotope 122 and the tagging agent 124, as indicated by block 126. The illustrated system 118 may also include a radiopharmaceutical dispensing system 128, which facilitates extraction of the radiopharmaceutical into a vial or syringe 130. In certain embodiments, the various components and functions of the system 118 are disposed within a radiopharmacy, which prepares the syringe 130 of the radiopharmaceutical for use in a nuclear medicine application. For example, the syringe 130 may be prepared and delivered to a medical facility for use in diagnosis or treatment of a patient.

FIG. 18 is a block diagram of an exemplary nuclear medicine imaging system 132 utilizing the syringe 130 of radiopharmaceutical provided using the system 118 of FIG. 12. As illustrated, the nuclear medicine imagining system 132 includes a radiation detector 134 having a scintillator 136 and a photo detector 138. In response to radiation 140 emitted from a tagged organ within a patient 142, the scintillator 136 emits light that is sensed and converted to electronic signals by the photo detector 138. Although not illustrated, the imaging system 132 also can include a collimator to collimate the radiation 140 directed toward the radiation detector 134. The illustrated imaging system 132 also includes detector acquisition circuitry 144 and image processing circuitry 146. The detector acquisition circuitry 144 generally controls the acquisition of electronic signals from the radiation detector 134. The image processing circuitry 146 may be employed to process the electronic signals, execute examination protocols, and so forth. The illustrated imaging system 132 also includes a user interface 148 to facilitate user interaction with the image processing circuitry 146 and other components of the imaging system 132. As a result, the imaging system 132 produces an image 150 of the tagged organ within the patient 142. Again, the foregoing procedures and resulting image 150 directly benefit from the radiopharmaceutical produced by the elution system 10 as illustrated and described with reference to FIGS. 1-15.

When introducing elements of the present invention or various embodiments thereof, the articles “a”, “an”, “the”, and “said” are intended to mean that there are one or more of the elements. The terms “comprising”, “including”, and “having” are intended to be inclusive and mean that there may be additional elements other than the listed elements. Moreover, the use of “top”, “bottom”, “above”, “below” and variations of these terms is made for convenience, but does not require any particular orientation of the components.

While the invention may be susceptible to various modifications and alternative forms, specific embodiments have been shown by way of example in the figures and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A radiopharmaceutical system, comprising:
a radioisotope generator assembly, comprising:
a radiation shield having a receptacle and a cover disposed over the receptacle; and
a radioisotope generator disposed in the receptacle below the cover; and
an eluate extraction mechanism, comprising:
an eluate conduit fluidly coupled to a hollow output needle of the radioisotope generator;
a radiation shielded housing coupled to an outside surface of the cover; and
a hollow needle fluidly coupled to the eluate conduit opposite the radioisotope generator wherein the hollow needle is disposed inside the radiation shielded housing.

2. The radiopharmaceutical system of claim 1, wherein the eluate conduit is disposed at least mostly within the radiation shield and the radiation shielded housing.

3. The radiopharmaceutical system of claim 1, wherein the hollow needle is mounted along a path of movement within the radiation shielded housing.

4. The radiopharmaceutical system of claim 1, further comprising an eluate container, wherein the eluate container is disposed removably inside the radiation shielded housing adjacent a door.

5. The radiopharmaceutical system of claim 4, wherein the radiation shielded housing comprises an alignment member disposed adjacent the eluate container opposite the door.

6. The radiopharmaceutical system of claim 1, further comprising an eluate container, wherein the eluate container is disposed inside an eluate container shield comprising a radiation shielding material, wherein the eluate container shield comprises an eluate container viewing window.

7. The radiopharmaceutical system of claim 1, further comprising an eluate container, wherein the eluate container is disposed inside an eluate container shield comprising a radiation shielding material, wherein an alignment adapter is disposed between the eluate container and the eluate container shield.

8. The radiopharmaceutical system of claim 1, wherein the radiation shielded housing is mounted on top of the cover.

9. The radiopharmaceutical system of claim 8, wherein the radiation shielded housing comprises an alignment portion disposed at least partially into a passage in the cover.

10. The radiopharmaceutical system of claim 9, wherein the eluate conduit extends through the alignment portion and the passage.

11. The radiopharmaceutical system of claim 1, wherein the hollow needle is coupled to a plunger via a releasable fastener.

12. The radiopharmaceutical system of claim 11, wherein the releasable fastener comprises a luer connector.

13. The radiopharmaceutical system of claim 1, comprising an eluant supply container fluidly coupled to the radioisotope generator.

14. The radiopharmaceutical system of claim 13, wherein the eluant supply container is disposed inside the radiation shield.

15.-24. (canceled)

25. A method of using a radiopharmaceutical system, the method comprising:
supplying an eluant into a radioisotope generator;
eluting a radioisotope in the radioisotope generator;
receiving an eluate at an output of the radioisotope generator; and
flowing the eluate from the output along an eluate conduit to a hollow needle that is removably inserted into an eluate container via a plunger, wherein flowing comprises transferring the eluate through a radiation shield disposed about the radioisotope generator and directly into a radiation shielded housing disposed outside the radiation shield, wherein the radiation shielded housing is disposed about the eluate container, the hollow needle, and at least a portion of the plunger.

26. The method of claim 25, wherein the eluate conduit is completely contained within the radiation shield and the radiation shielded housing.

27. The method of claim 25, comprising maintaining a continuous connection between the output and the eluate conduit during connections and disconnections between the hollow needle and the eluate container.

28. The method of claim 25, comprising enabling selective viewing of the eluate within the eluate container via a window.

29. The method of claim 25, comprising enabling selective access to the eluate container via a door.

30. The method of claim 25, comprising guiding the plunger along a path of movement between an engaged position and a disengaged position with the eluate container.
